(19) United States
(12) Patent Application Publication
(10) Pub. No.: US 2017/0328342 A1
(43) Pub. Date: Nov. 16, 2017

(54) POWER RAMP RATE LIMITER FOR WIND TURBINES

(71) Applicant: VESTAS WIND SYSTEMS A/S, Aarhus N (DK)

(72) Inventors: Martin Ansbjerg KJÆR, Harlev J (DK); Jesper Sandberg THOMSEN, Hadsten (DK); Robert GRØN-STEVENS, Randers (DK)

(21) Appl. No.: 15/532,871

(22) PCT Filed: Nov. 30, 2015
(86) PCT No.: PCT/DK2015/050365

§ 371 Date: Jun. 2, 2017

(30) Foreign Application Priority Data
Dec. 2, 2014 (DK) PA 2014 70756

(51) Int. Cl. F03D 7/02; H02P 9/10; H02J 3/38; F03D 9/25; F03D 80/80; H02K 7/18

(52) U.S. Cl. CPC F03D 7/028; F03D 80/82; H02K 7/1838; H02J 3/386; F03D 9/25; H02P 9/105; F05B 2240/912; F05B 2270/331

(57) ABSTRACT

The invention relates to a method for limiting structural loads in a wind turbine in situations where the power produced by the wind turbine is increased or decreased. The limitation of structural loads is achieved by restricting the power ramp rate, i.e. the rate of change of increases or decreases in produced power. The restriction is only invoked if a maximum change of the produced power or the corresponding internal power reference within a time window exceeds a given threshold.

### FIELD OF THE INVENTION

The invention relates to control of wind turbines, particularly to control of wind turbines in connection with power ramp rates.

### BACKGROUND OF THE INVENTION

Power ramping requirements originating from grid codes may be in conflict with protection of the mechanical components of wind turbines. Tower oscillations may be excited if a wind turbine follows a request to ramp the active power with large amplitude and high ramp rate. Tower oscillations may reduce the life-time of the wind turbine and should therefore be avoided as much as possible. As grid codes may set higher requirements to wind turbine's ability to change power from one set-point to another set-point, the structural requirements, e.g. in terms of the mechanical strength of the tower or other wind turbine components, may increase.

Accordingly, there is a need to improve the capability of wind turbines to handle power ramping requirements.

WO2013044927 discloses a method for operating a wind power plant, with at least one wind turbine generator and a power plant controller. The method includes the steps of receiving a request to reduce active power output from the wind power plant, dispatching a reference set point to the at least one wind turbine generator to lower a voltage level of the least one wind turbine generator, and the at least one wind turbine generator controls the voltage level of the least one wind turbine generator, to a new lower set point.

### SUMMARY OF THE INVENTION

It is an object of the invention to improve the control of a wind turbine in relation to handling power ramping requirements, particularly to handle large rate of change levels in power references provided from an external source to a wind turbine.

It is a further object of the invention to reduce structural loads and oscillations of wind turbine components due to changes in generated power as required by external power references.

In a first aspect of the invention there is provided a method for controlling a wind turbine, the method comprising
generating electric power corresponding to a generator reference dispatched to a generator,
monitoring the generator reference or the generated power,
determining a rate of change limit dependent on a change of the monitored generator reference or generated power within a predetermined period of time, and
restricting the rate of change of the generator reference, the restriction being performed according to the determined rate of change limit.

The generator reference is generally determined based on an external power reference provided from an external source to the wind turbine.

Advantageously, by restricting the rate of change of the generator reference dependent on a change of the monitored generator reference or generated power within a predetermined period of time, the wind turbine may be better able to handle large rate of change levels in external power references. Specifically, due to the possible restriction in changes of the generator reference, structural loads and oscillations of wind turbine components due to changes in generated power as dictated by the generator reference may be reduced.

According to an embodiment, the step of determining the rate of change limit comprises
selecting, as default, a first rate of change limit for the rate of change limit, and
selecting, dependent on the change of the monitored generator reference or generated power within the predetermined period of time, a second rate of change limit for the rate of change limit, wherein the absolute value of the first rate of change limit is greater than the absolute value of the second rate of change limit.

Accordingly, the power ramp rate limiter of the wind turbine may comprise two predefined rate of change limits. Generally, the ramp rate limiter may comprise two or more predefined rate of change limits such as three limits for increases in the generator reference. Similarly two or more limits may be defined for decreases in the generator reference.

According to an embodiment, the method according to the first aspect further comprises
monitoring at least one other operational parameter of the wind turbine in addition to the generator reference or the generated power, and
determining the rate of change limit dependent on a value relating to the monitored operational parameter and dependent on the change of the monitored generator reference or generated power within the predetermined period of time.

Advantageously, by determining the rate of change limit dependent both on a value relating to the monitored operational parameter and dependent on the change of the monitored generator reference or generated power a decision whether or not to restrict the rate of change of the generator reference can be based two different operational parameters of the wind turbine. For example, dependent on the value relating to the monitored operational parameter, the method may comprise a step of determining not to restrict the rate of change of the generator reference, irrespective of the change of the monitored generator reference or generated power.

According to an embodiment the at least one other operational parameter comprises structural loads or oscillations of a wind turbine component, and the value relating to the monitored operational parameter comprises a value relating to the monitored structural loads or oscillations.

Accordingly, if e.g. a tower oscillation is below a given threshold it may be determined not to restrict the rate of change of the generator reference, even if the change of the monitored generator reference or generated power would otherwise trigger a restriction of the power ramp rate.

According to an embodiment the at least one other operational parameter comprises a rotation speed of the generator, and the value relating to the monitored operational parameter comprises a value relating to the monitored rotation speed.

Accordingly, if e.g. the rotation speed is below a given threshold, e.g. the nominal rotation speed, it may be determined not to restrict the rate of change of the generator reference, even if the change of the monitored generator reference or generated power would otherwise trigger a restriction of the power ramp rate.

According to another embodiment the method may comprise determining the change of the monitored generator reference or generated power by determining a difference between maximum and minimum values of the monitored generator reference or generated power within the predetermined period of time.

According to another embodiment the method may comprise determining the change of the monitored generator reference or generated power within the predetermined period of time by low-pass filtering the signal of the generator reference or the generated power and determining a difference between the low-pass filtered signal and an unfiltered generator reference signal or generated power signal, or by determining a high-pass filtered generator reference signal or generated power signal.

According to an embodiment the method may further comprise determining the generator reference based on a received external power reference.

A second aspect of the invention relates to a ramping control system for a wind turbine, wherein the wind turbine comprises a power generator configured to generate power according to a received generator reference, the control system comprises
a power detector configured to monitor the generator reference or the generated power of the power generator, and
a ramp rate limiter configured to restrict a rate of change of the generator reference, the rate of change being restricted according to a rate of change limit and configured so that the rate of change limit is dependent on a change of the monitored generator reference or generated power within a predetermined period of time.

A third aspect of the invention relates to a wind turbine comprising a ramping control system according to the second aspect.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates a wind turbine,

FIG. 2 illustrates a wind turbine with a ramping control system 200,

FIGS. 3A-B illustrate an alternative configurations of the wind turbine with respect to the ramping control system,

FIG. 4 illustrates the function of the ramp rate limiter 202,

FIG. 5 illustrates how the rate of change of the generator reference is modified according to the rate of change limit, and

FIG. 6 illustrates how the rate of change of the generator reference is not modified due to a value relating to another monitored operational parameter.

### DESCRIPTION OF EMBODIMENTS

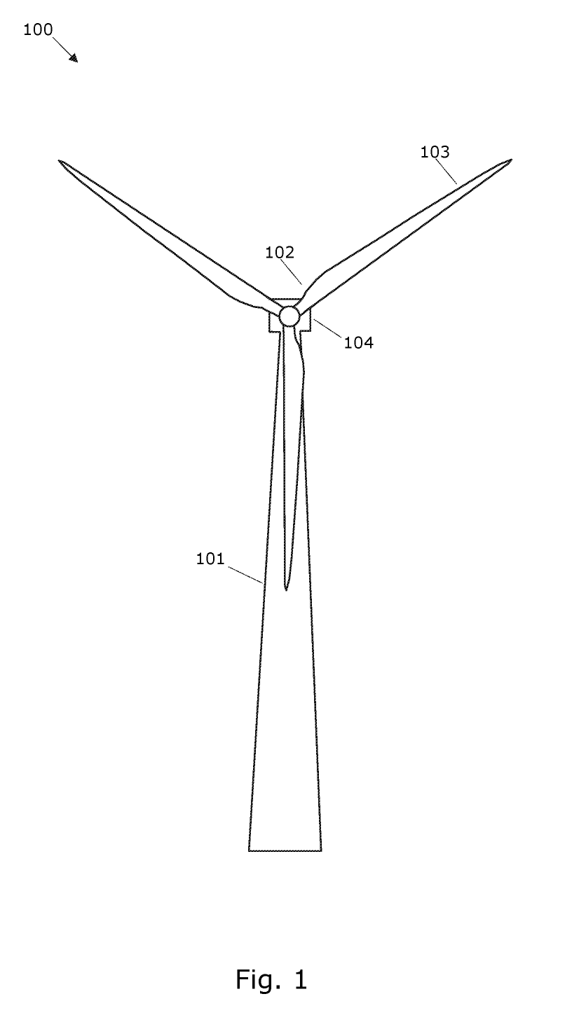

FIG. 1 shows a wind turbine 100 comprising a tower 101 and a rotor 102 with at least one rotor blade 103, such as three blades. The rotor is connected to a nacelle 104 which is mounted on top of the tower 101 and being adapted to drive a generator situated inside the nacelle. The rotor 102 is rotatable by action of the wind. The wind induced rotational energy of the rotor blades 103 is transferred via a shaft to the generator. Thus, the wind turbine 100 is capable of converting kinetic energy of the wind into mechanical energy by means of the rotor blades and, subsequently, into electric power by means of the generator. In this document the wind turbine 100 may also be referred to with the common abbreviation WTG (Wind Turbine Generator).

Structural components of the wind turbine such as the tower may be influenced by forces created due to changes in the power set point, i.e. when the generator is controlled to change the amount of produced power. Such structural oscillations affect the structural components with fatigue loads and may therefore reduce the lifetime of wind turbines. Accordingly, it may be desired to avoid such oscillations.

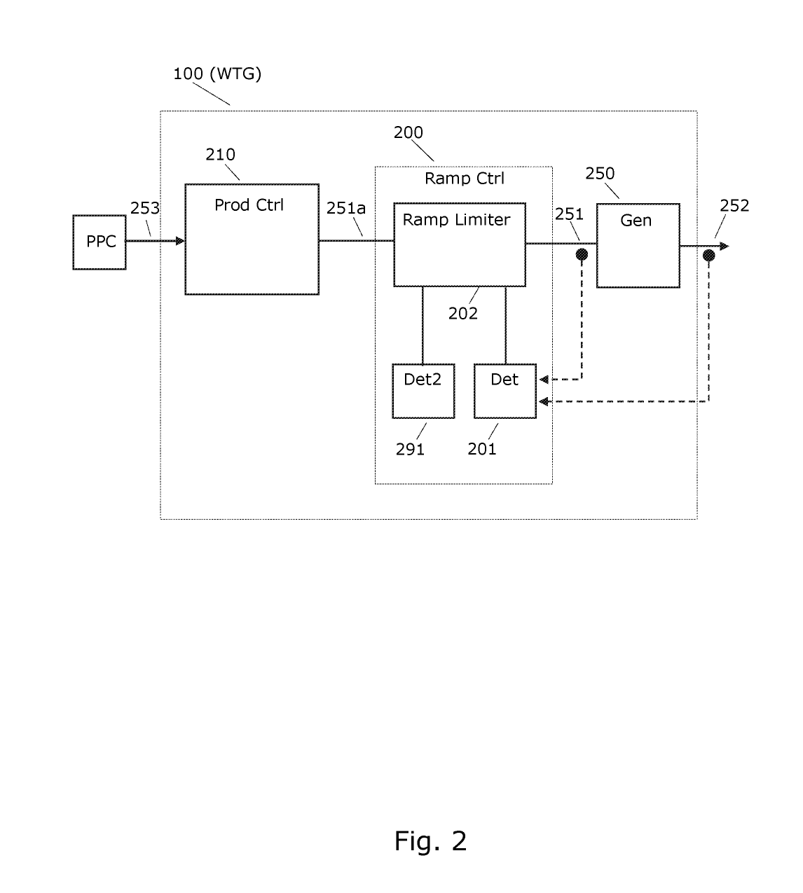

FIG. 2 illustrates the wind turbine 100 which comprises a power generator 250 configured to generate power 252 according to a received generator reference 251. Depending on the configuration of the power generator, the generator reference 251 may be in the form of a power reference or a torque reference which sets the desired amount of power to be produced by the generator 250. That is, the power generator may be configured to produce a desired amount of power set in terms of a torque reference or a power reference.

The wind turbine 100 may further comprise a power production controller 210 configured to determine an intermediate generator reference 251a based on a received external power reference 253. The power production controller 210 may determine the intermediate generator reference 251a dependent on operating conditions such as temperature, wind, pitch angle. Accordingly, the intermediate generator reference 251a may be equal to the external power reference or the intermediate generator reference 251a may be modified, e.g. reduced, by the power production controller 210.

The external power reference 253 may be an active power reference dispatched to a wind turbine from a central controller, e.g. a power plant controller PPC configured to control power production from one or more wind turbines. The level of the external power reference 253 may largely be determined by power commands from a grid operator, i.e. commands dictating a desired power production from the power plant. The power plant controller PPC determines the external power references 253 for the individual wind turbines, possibly dependent on other operating conditions.

The wind turbine 100 comprises a ramping control system 200 configured according to an embodiment of the invention. The ramping control system 200 comprises a power detector 201 configured to monitor the generator reference 251 or the generated power 252 of the power generator. The ramping control system 200 further comprises a ramp rate limiter 202 configured to restrict a rate of change of the generator reference 251 where the rate of change is restricted according to a rate of change limit and configured so that the rate of change limit is dependent on a change of the monitored generator reference 251 or generated power 252 within a predetermined period of time.

For example, the detector 201 could monitor the generator reference 251 or the generated power 252 of the power generator via supplied measurements of the power 251 or via monitoring of the generator reference outputted by the a ramp rate limiter 202.

The determination of the change of the monitored generator reference 251 or generated power 252 within a predetermined period of time may be performed by the detector 201 or the ramp rate limiter 202.

In comparison with the external power reference 253, the internal generator reference 251 is an internal reference, i.e. a reference used only internally in a given wind turbine. The generator reference 251 may in some situations be identical the external power reference 253, in other situations the generator reference 251 have been restricted relative to the external power reference 253, e.g. by the ramp rate limiter 202.

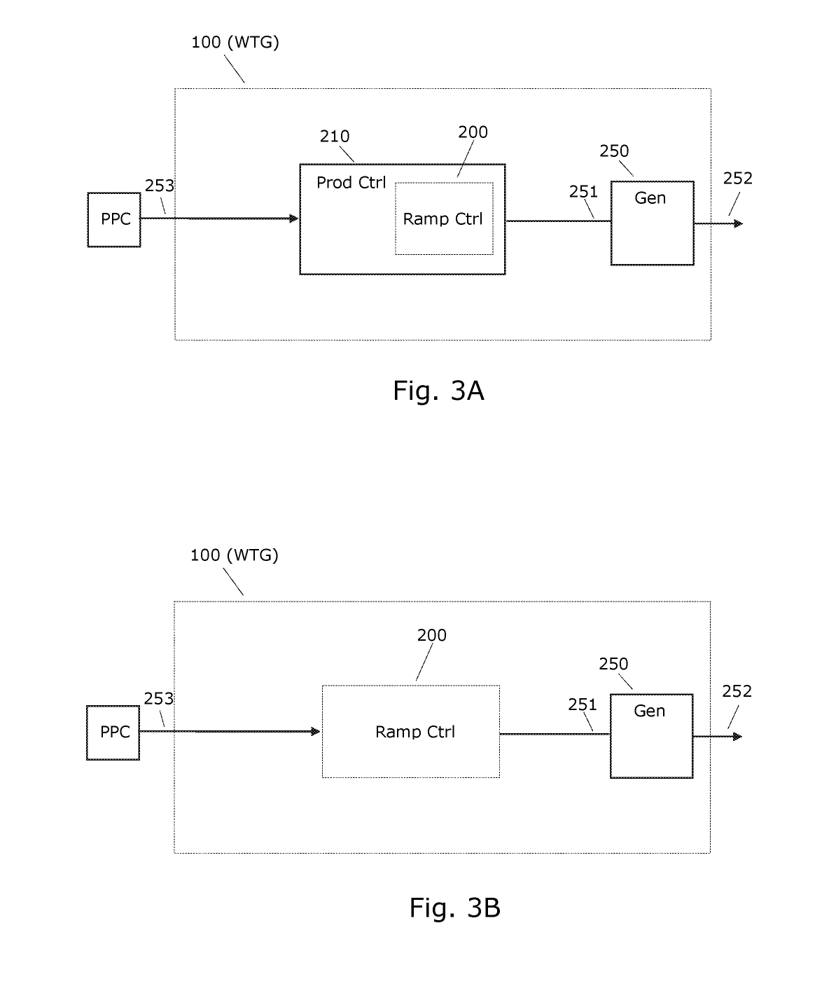

FIG. 3A illustrates an alternative configuration of the wind turbine 100 wherein the ramping control system 200 is arranged as a component of the power production controller 210.

FIG. 3B illustrates an yet another alternative configuration of the wind turbine 100 wherein the power production controller 210 is omitted and the ramping control system 200 is arranged to receive the external power reference 253 directly from the central controller, e.g. the PPC.

The ramping control systems 200 in FIGS. 2, 3A and 3B are configured equivalently to restrict the rate of change of the outputted generator reference 251 from the ramp rate limiter 202 based on an input power reference being in the form of the external power reference 253, the intermediate generator reference 251a or other reference derived from the external power reference 253.

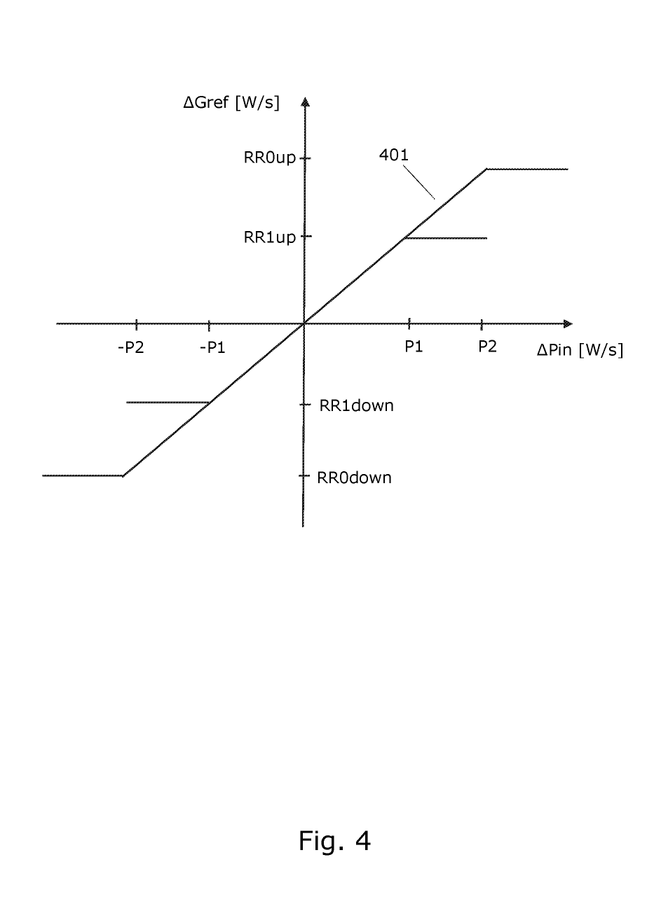

FIG. 4 illustrates the function of the ramp rate limiter 202. The ramp curve 401 illustrates that power variations over time of the power reference ΔPin (e.g. variation in the intermediate generator reference 251a) supplied to the ramp rate limiter 202 above the rate P2 is restricted to the maximum rate of change limit RR0up (for increases in Pin). The restricted or unrestricted rate of change of the generator reference output 251 from the ramp rate limiter 202 is denoted ΔGref. Dependent on a change of the monitored generator reference or generated power within a predetermined period of time the power variations in the supplied power reference Pin above the rate P1 is restricted to the restricted rate of change limit RR1up.

Accordingly, if the monitored generator reference 251 or generated power 252 increases above a given power variation threshold within a predetermined period of time (as determined by the detector 201 or ramp rate limiter 202), the ramp rate limiter determines the rate of change limit RR2up and restricts the maximum rate of change of the generator reference 251 according to the determined rate of change limit RR2up.

FIG. 4 shows that rate of change limits RR1down and RR0down apply for decreases in the power reference ΔPin below the rates −P1 and −P2, respectively. The absolute values of the restricted rate of change limits RR2down and RR2up may be equal or different. Accordingly, a rate of change limit RR2up may apply for increases in the generator reference 251 or generated power 252, whereas a different or no rate of change limit RR1down applies for decreases in the generator reference 251 or generated power 252.

The maximum allowed ramp rate limits RR0up and RR0down may be selectable, e.g. by the ramp rate limiter 202, as default first rate of change limits. The restricted ramp rate limits RR2up and RR1down may be selectable as second rate of change limits for the rate of change limit dependent on the change of the monitored generator reference or generated power within the predetermined period of time.

The absolute values of the default first rate of change limits RR0down, RR0up are greater than or equal to the absolute value of the second rate of change limits RR1down, RR1up. For example, RR0up may be greater than RR1up, whereas RR0down may be equal to RR1down.

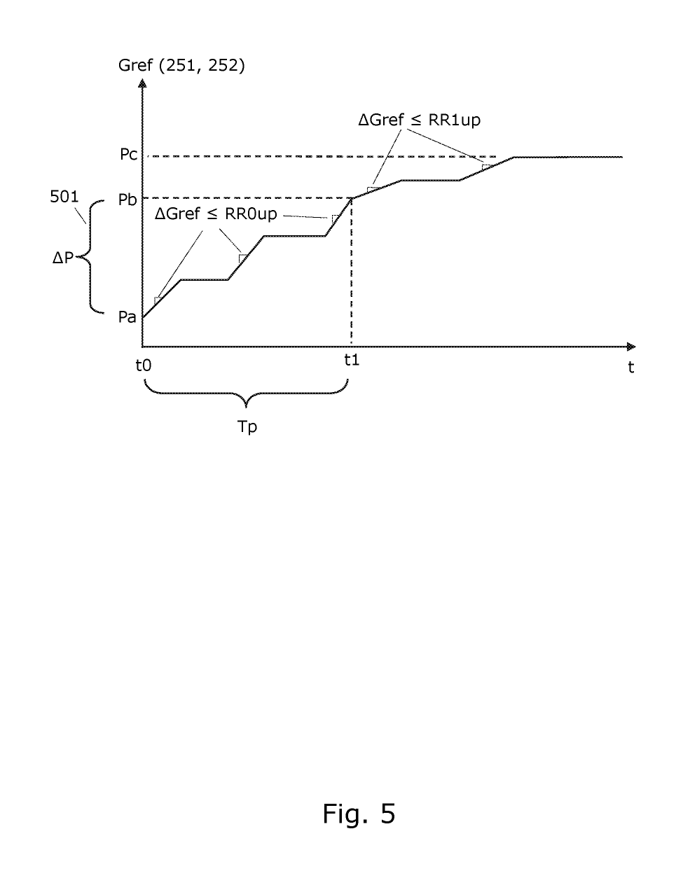

FIG. 5 illustrates how the rate of change of the generator reference Gref, 251 (and equivalently the generated power 252) may be modified according to the rate of change limit RR1up. Up to time t1 the generator reference Gref, 251 is increased stepwise in three steps. The rate of change of the generator reference 251 up to t1 is limited by the default first rate of change limit. Accordingly, the rate of changes ΔGref are equal to or less than the maximum rate of change limit RR0up up to time t1.

The stepwise increase of the generator reference 251 in FIG. 5 may be caused by a similar stepwise increase of the external power reference 253. The stepwise changes of the generator reference is only shown for illustrative purposes—that is, the generator reference need not be changed in steps, but could be changed in any way.

At time t1 the change of the monitored generator reference 251 or generated power 252 within a predetermined time triggers the a ramp rate limiter 202 to restrict the maximum rate of change of the generator reference 251 to the second rate of change limit RR2up. Accordingly, after time t1, the rate of change ΔGref is equal to or less than the first rate of change limit RR2up.

The generator reference 251 is increased up to the desired level Pc, but with a restricted ramp rate ΔGref.

The absolute value of the first rate of change limit is greater than the absolute value of the second rate of change limit

The change of the monitored generator reference 251 which triggers the ramp rate restriction, i.e. the restriction of the rate of change of the generator reference 251, may be determined as the power difference (Pb-Pa) 501 which has increased to the power variation threshold ΔP within the predetermined period of time Tp=t1-t0.

The change of the monitored generator reference 251 or generator power 252 may be determined by the detector 201, the ramp rate limiter 202 or other component of the ramping control system 200. In response to determination of 10 the change, a component of the ramping control system 200, e.g. the detector 201, may trigger the ramp rate limiter to invoke a restriction of the rate of change of the generator reference 251.

Referring again to FIG. 2, the ramping controller 200 may be configured with a further detector 291, Det2 configured to monitor at least one other operational parameter of the wind turbine in addition to the generator reference 251 or the generated power 252. Accordingly, the ramping controller 200 may be configured to determine the rate of change limit RR2up, RR1down dependent on a value relating to the monitored operational parameter and dependent on the change of the monitored generator reference or generated power within the predetermined period of time.

For example, dependent on the value relating to the monitored operational parameter, the ramping controller 200 may be configured to determine not to restrict the rate of change of the generator reference, irrespective of the change (e.g. Pb-Pa) of the monitored generator reference 251 or generated power 252.

Thus, if the monitored operational parameter is within acceptable limits, no restriction of the rate of change of the generator reference 251 is invoked, irrespective of a possible large increase of the monitored internal generator reference or generated power (e.g. Pb-Pa).

For example, the at least one other operational parameter may comprise structural loads or oscillations of a wind turbine component, and the value relating to the monitored operational parameter comprises a value relating to the monitored structural loads or oscillations. The wind turbine component could be the tower, the drive-train or one or more blades. The value relating to the monitored structural loads or oscillations could be an amplitude value, e.g. the acceleration amplitude of tower oscillations.

In another example, the at least one other operational parameter may comprise a rotation speed of the generator, and the value relating to the monitored operational parameter comprises a value relating to the monitored rotation speed. The value relating to the monitored rotation speed could be an absolute rotation speed value or a variational value of the rotation speed, e.g. a variational value representing max-min values within a period of time.

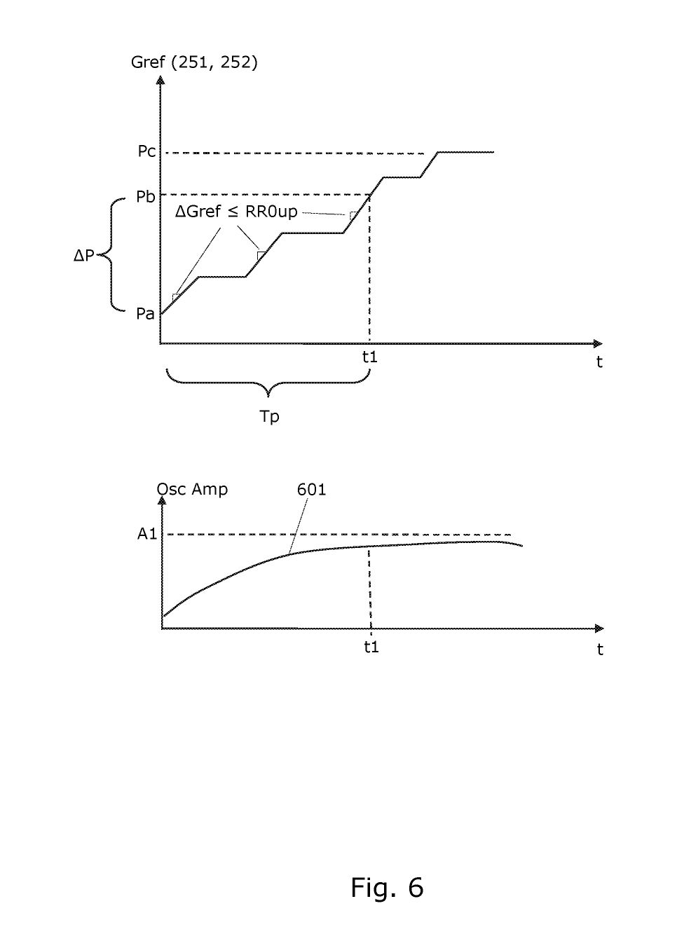

FIG. 6 illustrates an example where the value relating to the monitored operational parameter is the amplitude of tower oscillations 601. Up to time t1 the generator reference Gref, 251 increases as in FIG. 5. At time t1 the change of the monitored generator reference 251 or generated power 252 (Pb-Pa) within the predetermined time T1 would have been equal to the threshold ΔP and would according to an embodiment have triggered the ramp rate limiter 202 to restrict the rate of change of the generator reference 251 to the second rate of change limit RR1up. However, since the amplitude of tower oscillations 601 is below the tower oscillation threshold A1, the rate of change of the generator reference Gref, 251 is not restricted since the tower oscillation amplitude is below the threshold A1. Accordingly, the generator reference 251, Gref is allowed to increase up to the desired threshold Pc with the default rate of change limit RR0up.

Similarly, if the rotation speed of the generator is below a given threshold, e.g. a threshold close to the nominal rotation speed, the generator reference 251 may be allowed to change according the default rate of change limit RR0up, RR0down, even though the generator reference 251 has changed more than ΔP over the predetermined period Tp.

The change of the monitored generator reference 251 or generator power 252 may be determined in different ways, for example by determining a difference between maximum and minimum values of the monitored generator reference or generated power within the predetermined period of time Tp.

In another example, the change of the monitored generator reference or generated power may be determined by low-pass filtering the signal of the generator reference or the generated power and by determining a difference between the low-pass filtered signal and an unfiltered generator reference signal or generated power signal. Alternatively, the change of the monitored generator reference or generated power may be determined by high-pass filtering the generator reference signal or generated power signal and the output from the high-pass filter is used as a value for the change of the monitored generator reference 251.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain features are recited in mutually different dependent claims does not indicate that a combination of these features cannot be used to advantage. Any reference signs in the claims should not be construed as limiting the scope.

1. A method for controlling a wind turbine, the method comprising:
generating electric power corresponding to a generator reference dispatched to a generator,
monitoring the generator reference or the generated power, and at least one other operational parameter of the wind turbine;
determining a rate of change limit dependent on a change of the monitored generator reference or generated power within a predetermined period of time (Tp) as well as the at least one other operational parameter, and
restricting the rate of change of the generator reference according to the determined rate of change limit.

2. The method according to claim 1, wherein determining the rate of change limit comprises:
selecting, as default, a first rate of change limit for the rate of change limit, and
selecting, dependent on the change of the monitored generator reference or generated power within the predetermined period of time and the and at least one other operational parameter, a second rate of change limit for the rate of change limit, wherein the absolute value of the first rate of change limit is greater than the absolute value of the second rate of change limit.

3. The method according to claim 2, comprising:
dependent on the value relating to the monitored operational parameter, determining to restrict the rate of change of the generator reference to a default rate of change limit, irrespective of the change of the monitored generator reference or generated power.

4. The method according to claim 1, wherein the at least one other operational parameter comprises a value relating to a monitored structural load of a wind turbine component.

5. The method according to claim 1, wherein the at least one other operational parameter comprises a value relating to a monitored oscillation of a wind turbine component.

6. The method according to claim 1, wherein the at least one other operational parameter comprises a value relating to the monitored rotation speed of the generator.

7. The method according to claim 1, comprising:
determining the change of the monitored generator reference or generated power by determining a difference between maximum and minimum values of the monitored generator reference or generated power within the predetermined period of time.

8. The method according to claim 1, comprising:
determining the change of the monitored generator reference or generated power within the predetermined period of time by low-pass filtering the signal of the generator reference or the generated power and determining a difference between the low-pass filtered signal and an unfiltered generator reference signal or generated power signal, or by determining a high-pass filtered generator reference signal or generated power signal.

9. The method according to claim 1, further comprising:
determining the generator reference based on a received external power reference.

10. A ramping control system for a wind turbine, wherein the wind turbine comprises a power generator configured to generate power according to a received generator reference, the control system comprises:
a power detector configured to monitor the generator reference or the generated power of the power generator, and
a ramp rate limiter configured to restrict a rate of change of the generator reference, the rate of change being restricted according to a rate of change limit and configured so that the rate of change limit is dependent on a change of the monitored generator reference or generated power within a predetermined period of time.

11. (canceled)

12. A wind turbine, comprising:
a tower;
a nacelle disposed on the tower and comprising a power generator configured to generate power according to a received generator reference; and
a ramping control system, comprising:
a power detector configured to monitor the generator reference or the generated power of the power generator, and
a ramp rate limiter configured to restrict a rate of change of the generator reference, the rate of change being restricted according to a rate of change limit and configured so that the rate of change limit is dependent on a change of the monitored generator reference or generated power within a predetermined period of time.
